(19) United States
(12) Patent Application Publication
(10) Pub. No.: US 2014/0284507 A1
(43) Pub. Date: Sep. 25, 2014

(54) AUXILIARY VALVE CONTROLLED SELF-CLEANING MAIN VALVE

(71) Applicant: József Bereznai, Budapest (HU)

(72) Inventor: József Bereznai, Budapest (HU)

(73) Assignee: BERY INTELLECTUAL PROPERTIES Szeliemi Tulajdonjogo kat Hasznosito es Kezelo Korlatolt Felelossoo, Budapest (HU)

(21) Appl. No.: 14/009,059

(22) PCT Filed: Mar. 30, 2012
(86) PCT No.: PCT/HU2012/000024

§ 371 Date: Sep. 30, 2013

(30) Foreign Application Priority Data
Apr. 1, 2011 (HU) P1100179

(51) Int. Cl. F16K 31/124; F16K 31/524

(52) U.S. Cl. CPC F16K 31/124; F16K 31/524
USPC 251/25; 251/63.6

(57) ABSTRACT

Auxiliary valve controlled self-cleaning main valve with mechanical operating means. The valve body (1) of the main valve has an inlet (2) and an outlet (3) interconnected through a flow-through opening, and a movable piston (6) having a main closing element (8) at one of its sides and a brake O-ring (9) at its other side. In the control chamber (5) an auxiliary valve (4) with a control valve stem (7) is provided. Between the piston (6) and the auxiliary valve (4) a compressible spring (12) is positioned. The mechanical operating means is provided with a wedge travel path and adapted to press the control valve stem (7) when force is applied externally and to keep it pressed in without applying external force, further it is adapted to release it when force is applied externally and to keep it released without applying external force.

The invention relates to an auxiliary valve controlled self-cleaning main valve with mechanical operating means, especially for high capacity pipelines. In another approach it is an indirectly controlled valve with an auxiliary valve provided with a mechanism for keeping it permanently in an open or closed state. More specifically, the invention is a main valve the valve body of which is provided with an inlet opening and an outlet opening which are interconnected with a flow-through opening, a movable piston at one side of which there is a main closing element for closing the flow-through opening when the piston is in one of its end position, at the other side of the piston there is a brake O-ring bordering a control chamber, the brake O-ring is in contact with the wall of the control chamber defining a first amount of liquid flow-through A1. At the side of the control chamber opposite the flow-through opening an auxiliary valve with a control valve stem is provided having a sealed auxiliary valve closing element at its one end and a sealed guiding element at its other end. In an open position of the auxiliary valve closing element the flow-through opening of the auxiliary valve and the lead-out opening of the control chamber define a second amount of liquid flow-through A2. Between the piston and the auxiliary valve a compressible spring is positioned in their common axis line.

In pipelines especially in vast, high capacity pipe systems in case of valves functioning for opening/closing, for example ball taps and other conventional taps, the unidirectional flow within the valve, the scale build-up and/or dirt which deposits in it in its closed state may cause clogging and unreliable operation of the valve. A solution to eliminate this problem by a valve having a control, chamber is described in patent application U.S. Pat. No. 7,175,154. However, experiences during its use show that the sealing element or O-ring is susceptible to cling to the side Walls if the valve is not used for a long time. This is particularly true for valves which are kept permanently open or closed because of the nature of application. This means that greater force is needed to move the auxiliary piston which is not ensured by the applied low-force operating mechanisms. These mechanisms are hand operated, use press-buttons, they lack force increasing mechanical transmission even if electromagnetic operating means are used.

In case of opening/closing valves with an auxiliary valve, auxiliary chamber, a spring is applied between the control auxiliary piston and the closing main piston. By increasing the spring force the momentary stuck caused by the aforementioned clinging can be eliminated, however, to this again the force required for operating the valve stem of the control piston must be increased.

Reliable operation of the auxiliary valve in any circumstances by means of a simple, cheap but effective mechanism must be ensured. This does not mean that high capacity control of the auxiliary valve stem is required. Merely, force necessary to start the stem after a possible jam is needed. To solve this problem a mechanism provided with a wedge travel path according to the present invention is used in number of different but simple embodiments. Known opening/closing valves with auxiliary valve operate reliably even under the most varied pressure conditions. They can be operated without any difficulties even in case of large quantity liquid flow-through. However, closing may present a problem since if large amount of water flowing in the pipe is shut off it gives rise to significant mechanical impulse change causing jerks in the pipeline and in the closing valve. Consequently, the valve should be made of a stronger, thicker material and also, more material should be used for making it. The velocity of water shutoff may be predetermined and set somehow e.g. in a programmable manner, however, this would require expensive control means, for example a motor driven closing mechanism. According to the solution of the aforementioned patent application U.S. Pat. No. 7,175,154 a closing velocity determined by the construction is set during manufacture of the valve which can be adjusted to pressure conditions within a certain range. Fortunately, this range is wide enough so the automatic operation is irrespective of the usual pressure fluctuation.

The programmable piston structure according to patent application U.S. Pat. No. 7,175,154 is suitable for retarted closing of the valves. Duration of opening and closing can be timed from seconds to minutes. The piston of the valve accomplishing the main closing is mechanically coupled to an auxiliary valve operating in an auxiliary chamber and the force acting on it is much smaller than on the main closing piston. The essence of the solution is that the control function of the auxiliary valve is ensured in such a manner that the sealing element, e.g. O-ring of the auxiliary valve allows a liquid flow-through in a certain amount resulting from the pressure differences between the two sides. At the same time by means of this auxiliary piston and the structured or unstructured surface damages which make flow-through possible, and by means of other mechanical structures the auxiliary chamber is filled up and succeedingly emptied. In this manner cyclical bidirectional flow of the liquid is ensured. It is advantageous because scale build-up-and dirt deposition can be eliminated.

The velocity of closing according to the solution of the present invention can be set by adjusting the liquid flow-through at the brake O-ring of the main closing piston. However, as it was previously mentioned, the degree of force acting on the control valve stem should be planned suitably high. In order to ensure it under any circumstances by using simple, especially hand-powered means, a simply designed mechanism provided with a wedge travel path according to the present invention is used. These mechanisms are known. However, in combination with the valve construction according to the aforementioned earlier patent application they provide a solution to the problem specified.

To reach the goal an auxiliary valve controlled self-cleaning main valve with 7 mechanical operating means according to the preamble is provided wherein the mechanical operating means is provided with a wedge travel path and is adapted to press the control valve stem in axial direction when force is applied externally and to keep it pressed in without applying external force, further it is adapted to release it when force is applied externally and to keep it released without applying external force.

A detailed description of the invention will be given with reference to the accompanying schematic cross-sectional drawings in which:

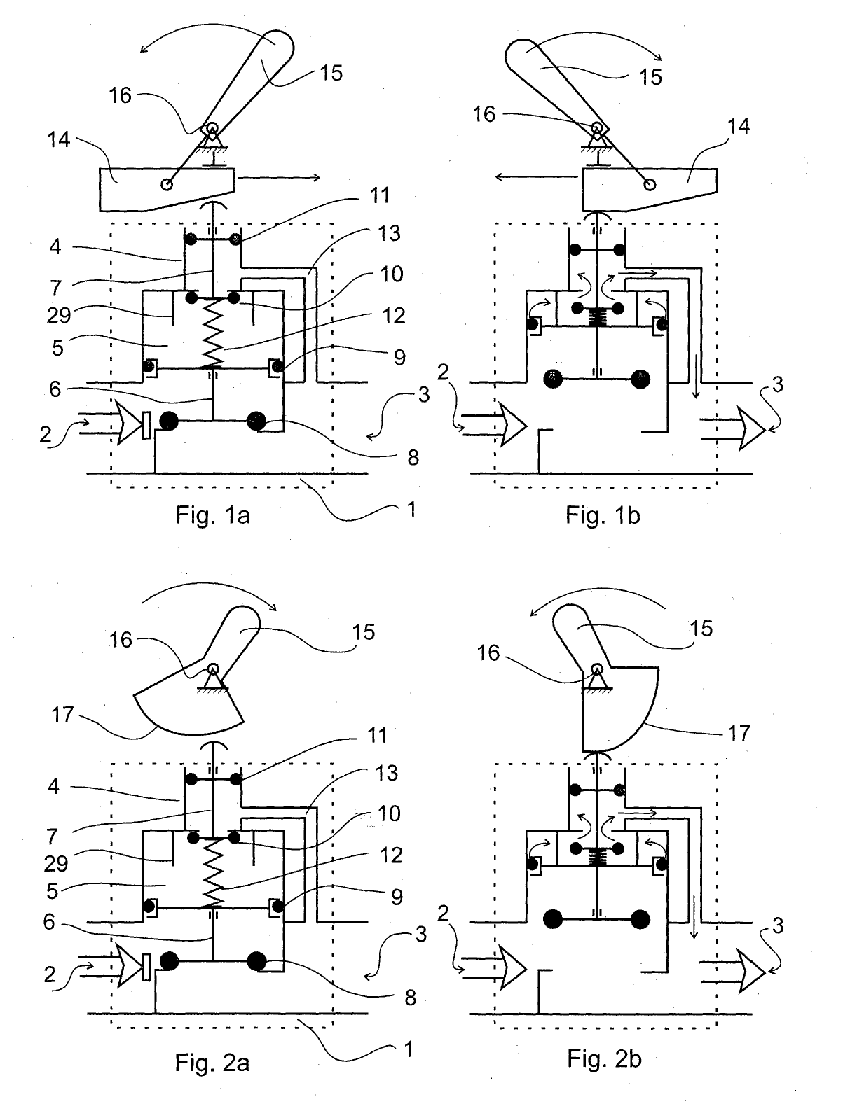

FIG. 1a shows the mode of operation with a sliding wedge, closed state, first embodiment;

FIG. 1b shows the mode of operation with a sliding wedge, open state, first embodiment;

FIG. 2a shows the mode of operation with a curved wedge travel path, closed state, second embodiment;

FIG. 2b, shows the mode of operation with a curved wedge travel path, open state, second embodiment;

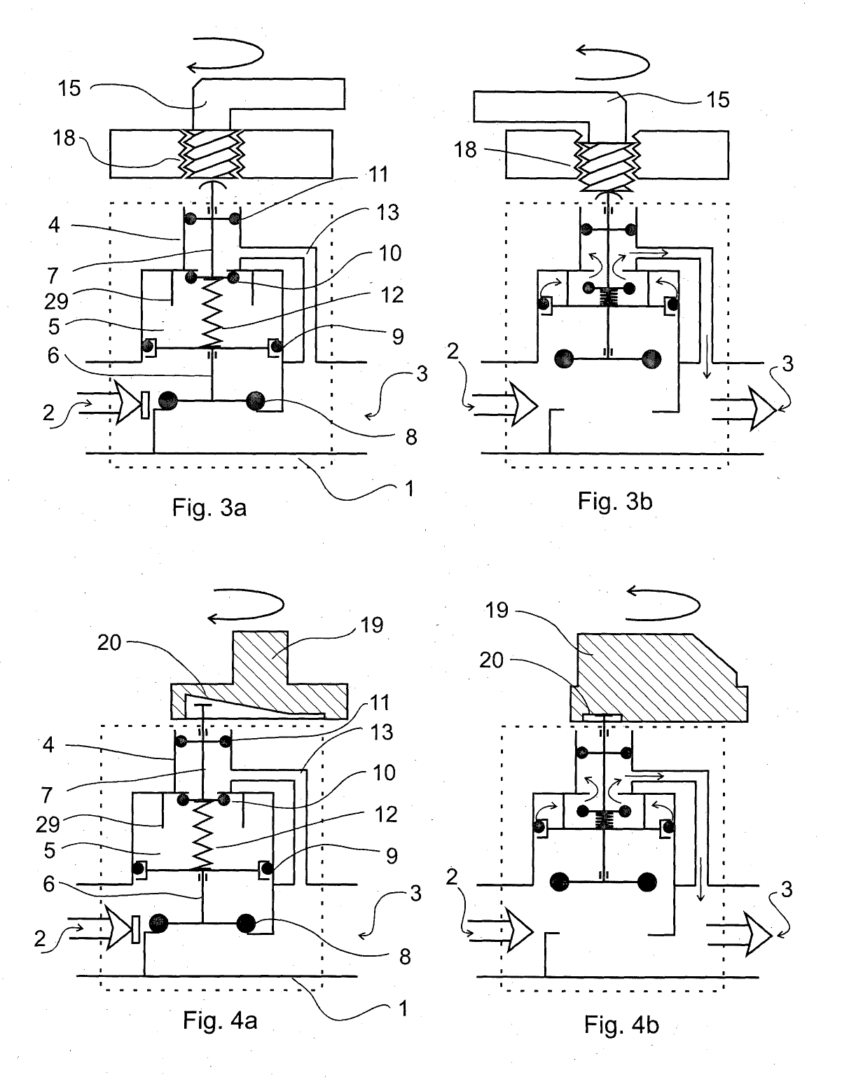

FIG. 3a shows the mode of operation with screw threads, closed state, third embodiment;

FIG. 3b shows the mode of operation with screw threads, open state, third embodiment;

FIG. 4a shows the mode of operation with a circular wedge travel path in a rotating head, closed state, fourth embodiment;

FIG. 4b shows the mode of operation with a circular wedge travel path in a rotating head, open state, fourth embodiment;

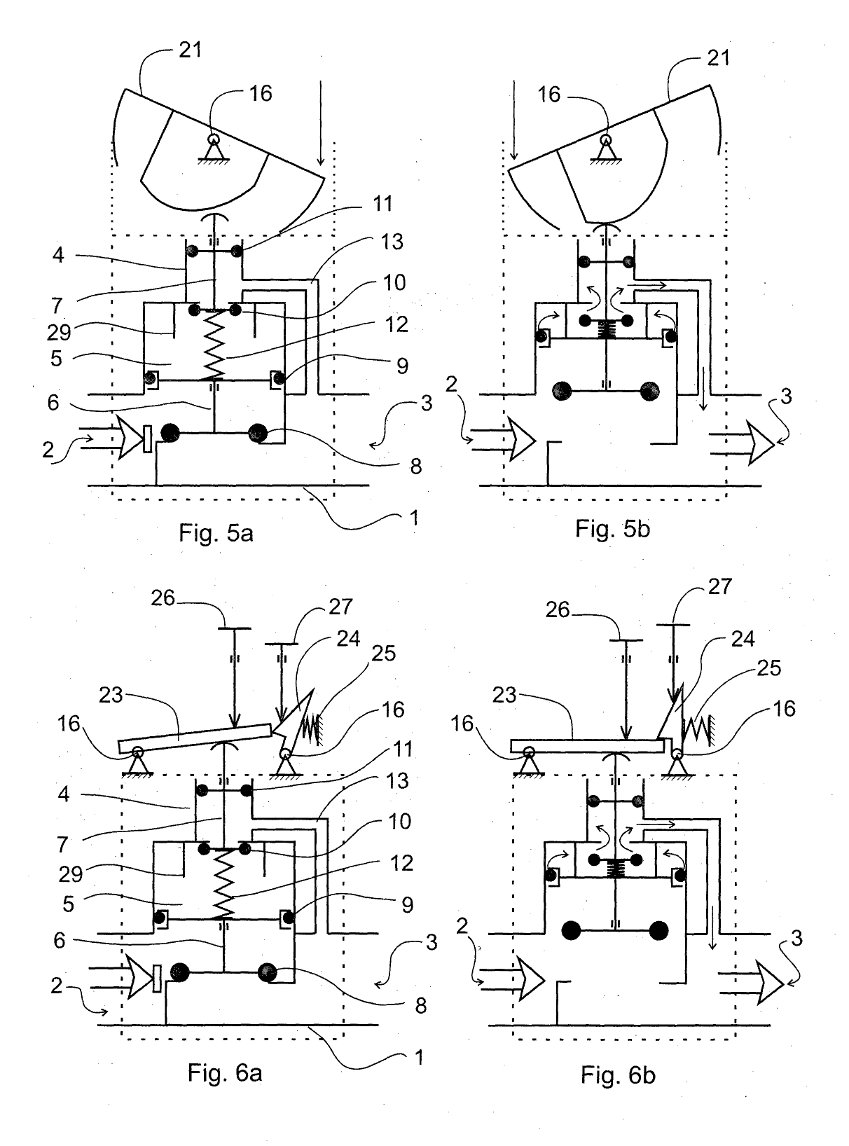

FIG. 5a shows the mode of operation with a rocker switch, closed state, fifth embodiment;

FIG. 5b shows the mode of operation with a rocker switch, open state, fifth embodiment;

FIG. 6a shows the mode of operation with an on/off press-button, closed state, sixth embodiment;

FIG. 6b shows the mode of operation with an on/off press-button, open state, sixth embodiment;

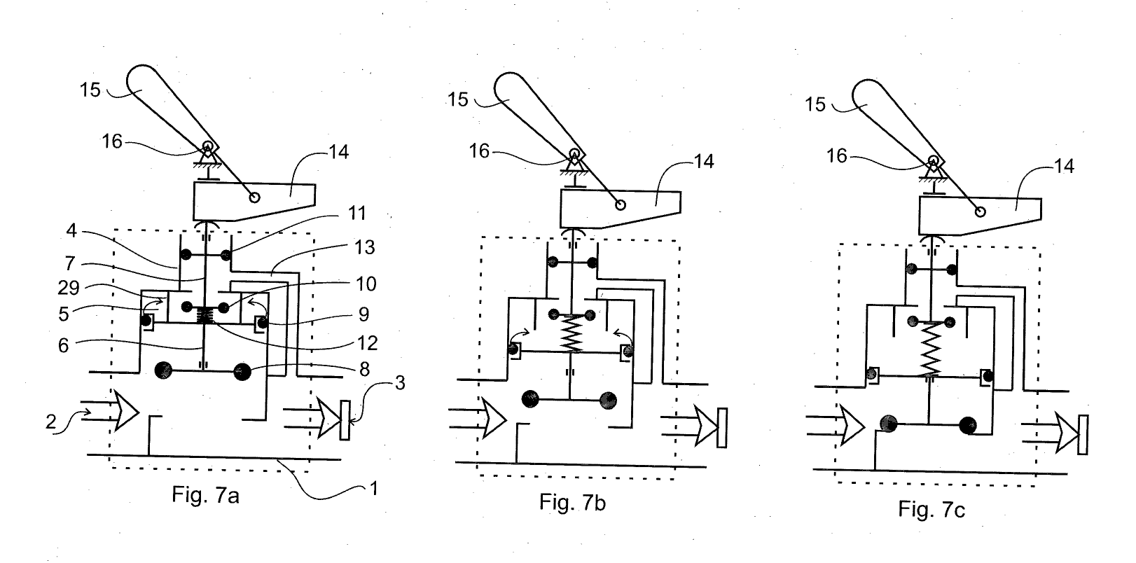

FIGS. 7a, 7b, 7c shows the stages of the self-cleaning process in relation to the first embodiment;

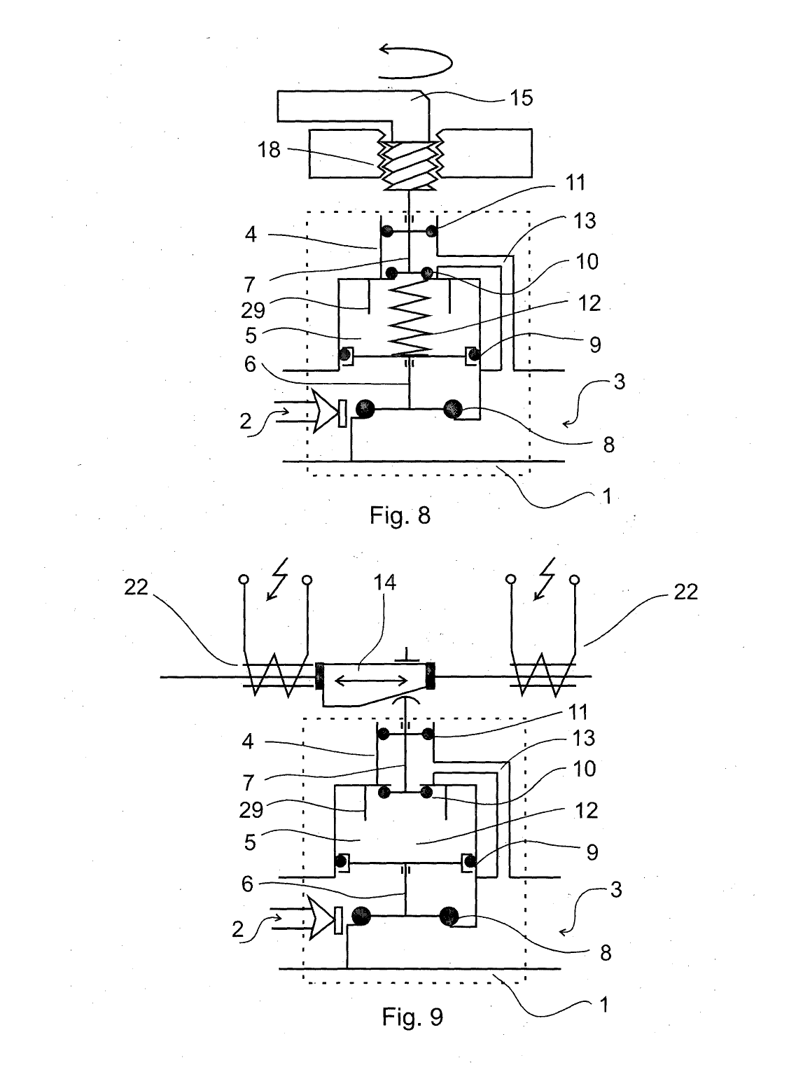

FIG. 8 shows the mode of operation with a screw, closed state, seventh embodiment; and

FIG. 9 shows the mode of operation with electromagnets, closed state, eighth embodiment.

According to a first embodiment of the invention shown in FIGS. 1a and 1b valve body 1 comprises an inlet opening 2 and an outlet opening 3 which are interconnected with a flow-through opening. The part enclosed in the square marked with a broken line illustrates an earlier patent of the present inventors which is adapted to the present invention as it will be set forth in the following description.

The main flow-through opening of valve body 1 can be closed or opened depending on the position of piston 6 by means of a main closing element 8. The main closing element is positioned at one (the bottom) side of piston 6 while at the other (the upper) side of it a brake O-ring 9 bordering control chamber 5 is provided. As seen in the Figure, upward movement of piston 6 is limited by bumpers 29. These bumpers may be separated elements or a single piece of tube having suitably large openings.

On a side of control chamber 5 an auxiliary valve 4 is provided the flow-through opening of which makes flow of liquid from control chamber 5 to the low-pressure space possible through the lead-away channel (pipe, bore-hole) 13. Flow-through opening of auxiliary valve 4 can be closed by auxiliary valve closing element 10 of control valve stem 7. Spring 12 forces control valve stem 7 and piston 6 in a closed state which is considered as the normal state of the valve. Advantageously, lead-away channel 13 is connected to outlet opening 3. Preferably, a seal 11 may be placed on control valve stem 7. Seal 11 can be a rubber sheet membrane closing element which prevents liquid flowing through auxiliary valve 4 from getting out.

By pressing control valve stem 7 in, auxiliary valve closing element 10 moves away from the flow-through opening of control chamber 5 and liquid is able to leave control chamber 5 through lead-away channel 13, since its flow-through capacity is greater than that of the control opening of the piston. Brake O-ring 9 bordering control chamber 5 leans against the wall of control chamber 5 determining a first amount of liquid flow-through A1. At the same time in an open state of the auxiliary valve closing element 10 the flow-through opening of the auxiliary valve 4 and a lead-out opening of control chamber 5 collectively determine a second amount of liquid flow-through A2. Liquid flow-through A2 is always significantly greater than liquid flow-through A1.

In the present example the lead-out opening of control chamber 5 is a lead-away channel 13. In other embodiments it may be a simple bore-hole or other opening.

The pressure acting on piston 6 at inlet 2, causes displacement of piston 6 and the main closing element 8 moves away from flow-through opening of valve body 1, the valve opens and liquid entering through inlet 2 will leave through outlet 3.

If control valve stem is not pressed in, spring 12 and the pressure acting at inlet 2 cause auxiliary valve closing element 10 to return and close the flow-through opening of auxiliary valve 4. Then liquid starts filling up control chamber 5 and spring 12 as well as the pressure acting on a portion of the piston 6 facing control chamber 5 cause the piston 6 and its main closing element 8 to return and close the flow-through opening of valve body 1.

Control valve stem 7 may be pressed in or operated in several manners, wherein either in an open state or in a closed state the operating mechanism is fixed, it is not able to move by itself.

According to the first embodiment shown in FIGS. 1a and 1b it is pressed in by means of a wedge 14 operated by means, of an arm 15 for moving along a slide-path. In FIG. 1a the valve is shown in its-closed state when control valve stem 7 is not pressed by wedge 14. In FIG. 1b auxiliary valve 4 and also the main valve are in open state as arm 15 is turned about the centre of rotation 16 to its opposite end-position. In this manner control valve stem 7 becomes pressed in because of the force exerted by wedge 14 connected to arm 15.

In each of the embodiments illustrated with reference to the Figures the part enclosed in the square marked with a broken line i.e. the auxiliary valve controlled main valve is shown unchanged since it is not considered as a novel solution. The structure and operation of it can be learned e.g. from the above mentioned U.S. Pat. No. 7,175,154 document. In the embodiments of the present invention this is provided 20 with a lead-away channel 13 and realized in combination with a mechanism provided with a wedge travel path for exerting force on control valve stem 7.

Another embodiment can be seen in FIGS. 2a and 2b. FIG. 2a shows the valve in its closed state while FIG. 2b shows the open state. In this embodiment control valve stem 7 is pressed in substantially eccentrically by a curved wedge travel path 17 which can be moved about the centre of rotation 16 by means of arm 15 between the two end-positions.

In the embodiment of FIGS. 3a and 3b control valve stem 7 is opened by means of threaded axle 18 which is rotated by means of arm 15. Advantageously the pitch of threads 18 is chosen in such a manner that the control valve stem 7 be pressed in an extent correspondent to the required angle of rotation of arm 15.

In the embodiment shown in FIG. 4a opening of the control valve stem 7 in a rotating head 19 is accomplished by means of a circular wedge travel path 20 which is not able to move control valve stem 7. FIG. 4a illustrates that by rotating the circular wedge travel path 20 in the rotating head 19 the control valve stem 7 becomes pressed in and opens auxiliary valve 4.

In the embodiment according to FIGS. 5a and 5b wedge travel path—which as a matter of fact is an eccentric curved surface—is turned by means of a rocker switch which is similar to electric switches. As it is shown in FIG. 5a control valve stem 7 defines a state of rest or closed state for the valve. In case of FIG. 5b the rocker switch 21 is tilted in the opposite direction through the centre of rotation 16 causing the wedge travel path to press control valve stem 7 so auxiliary valve 4 opens.

In FIGS. 6a and 6b an embodiment provided with a latch and operated by means of an on/off press-button can be seen. FIG. 6a shows the closed normal position. When a device similar to a press-button 26 is pressed down an arm 23 turns about the centre of rotation 16 and presses control valve stem 7 in. Then a latch 24 provided with a wedge travel path surface holds, arm 23 in its lower position due to the spring force exerted by latch-spring 25, this is shown in, FIG. 6b. The latch can be disengaged by pressing the device similar to a press-button 26, and by means of spring 12 the control valve stem 7 returns to its normal position and auxiliary valve 4 will close.

In FIGS. 7a, 7b and 7c the self-cleaning mechanism is shown in relation to the embodiment of FIGS. 1a and 1b. In general, there is a pressure difference between inlet 2 and outlet 3. Because of this pressure difference piston 6 becomes in the open state. When there is no consumption, e.g. at night, the pressure in the valve is equalized at inlet opening 2 and outlet opening 3. Then the pressure at inlet opening 2 equals to the pressure in control chamber 5, as a result of which piston 6 is able to move in the pressure equalized space in the closing direction and closes due to the force exerted by spring 12. If there is no consumption during the whole closed period the valve will close and remain in this state of rest until whatever little-consumption starts. If the pressure at outlet opening 3 drops as a result of consumption, pressure in control chamber 5 also drops relative to the pressure at inlet opening 2 and piston 6 will immediately move in the opening direction. Travel of piston 6 does not always end in closing sometimes it is only displaced thereby preventing the structure from getting stuck or jammed. In this manner a reliable closing element is provided. When a piston structure according to the above mentioned patent application U.S. Pat. No. 7,175,154 is used, the dirt which by chance got stuck in can leave because of the displaceable O-ring, thus the control openings are flushed out every time and become clean. In this manner a self-cleaning valve is provided.

In the embodiment according to FIG. 8 control valve stem 7 is pressed to the closing surface of the auxiliary valve by means of threads 18. Threads 18 can be rotated by means of arm 15.

In the embodiment shown in FIG. 9 the control valve stem 7 is pressed in by means of a wedge 14 which is movable in a direction relative to the control valve stem 7 in a given angle, preferably right angle. Wedge 14 can be moved by means of electromagnets 22. A significant advantage of this solution is that the moving wedge 14 becomes fixed in its both end-positions, as a consequence of which only energy-saving impulse-like operation of electromagnets 22 is needed, i.e. only for the time of switch-over then they can be turned off.

The above described embodiments using a mechanical transmission by means of a wedge travel path are merely examples. Other solutions based on similar principles are also feasible without departing from the scope of the invention as defined in the appended claims. For example the mechanical structure provided with a wedge travel path for increasing force can be driven directly or indirectly, by hand, by means of pneumatic or electric actuator, even by means of other controllable actuator operated by the hydraulic pressure. Embodiments of the present invention can effectively be used for replacing conventional taps, ball taps operating under usual circumstances. A further advantage of the present solution is that no maintenance is required even at places where long closing or opening time is allowed for in which case scale build-up and/or dirt deposition would be damaging and maintenance would be difficult, for example valves used in underground water supply systems, valves built in walls or valves used at protected establishments, distant premises.

1. Auxiliary valve controlled self-cleaning main valve with mechanical operating means wherein the valve body (1) of the main valve is provided with an inlet (2) and an outlet (3) which are interconnected through a flow-through opening, a movable piston (6) at one side of which there is a main closing element (8) for closing the flow-through opening when said piston (6) is in one of its end position, at the other side of said piston (6) there is a brake O-ring (9) bordering a control chamber (5), said brake O-ring (9) is in contact with the wall of said control chamber (5) defining a first amount of liquid flow-through (A1); at the side of said control chamber (5) opposite the flow-through opening an auxiliary valve (4) with a control valve stem (7) is provided having a sealed auxiliary valve closing element (10) arranged axially at its one end and a sealed guiding element arranged at its other end; in an open state of said auxiliary valve closing element (10) the flow-through opening of said auxiliary valve (4) and a lead-out opening of said control chamber (5) define a second amount of liquid flow-through (A2); between said piston (6) and said auxiliary valve (4) in their common axis line a compressible spring (12) is positioned, characterized in that said mechanical operating means is provided with a wedge travel path and is adapted to press said control valve stem (7) in axial direction when force is applied externally and to keep it pressed in without applying external force, further it is adapted to release it when force is applied externally and to keep it released without applying external force.

2. Auxiliary valve controlled self-cleaning main valve with mechanical operating means according to claim 1 characterized in that said lead-out opening of said control chamber (5) is a lead-away channel (13).

3. Auxiliary valve controlled self-cleaning main valve with mechanical operating means according to claim 2 characterized in that the other end of said lead-away channel discharges into said outlet (3) of said valve body (1).

4. Auxiliary valve controlled self-cleaning main valve with mechanical operating means according to any of claims 1-3 characterized in that the wedge travel path of said mechanical operating means is a curved wedge travel path (17) moving about a centre of rotation (16).

5. Auxiliary valve controlled self-cleaning main valve with mechanical operating means according to any of claims 1-3 characterized in that the wedge travel path of said mechanical operating means is a threaded axle (18) turnable by means of an arm (15).

6. Auxiliary valve controlled self-cleaning main valve with mechanical operating means according to any of claims 1-3 characterized in that the wedge travel path of said mechanical operating means is a circular wedge travel path (20).

7. Auxiliary valve controlled self-cleaning main valve with mechanical operating means according to any of claims 1-3 characterized in that said mechanical operating means is a rocker switch (21) having a centre of rotation (16) and provided with an eccentric curved surface.

8. Auxiliary valve controlled self-cleaning main valve with mechanical operating means according to any of claims 1-3 characterized in that said mechanical operating means comprises a device similar to a press-button (26) and an arm (23) having a centre of rotation (16), and a further device similar to a press-button (27) and an additional latch (24) having a wedge travel path surface and a latch-spring (25).

9. Auxiliary valve controlled self-cleaning main valve with mechanical operating means according to any of claims 1-3 characterized in that said mechanical operating means is a wedge (14) movable by means of electromagnets (22) in a direction relative to said control valve stem (7) in a given angle and can be fixed in its both end-positions.

10. Auxiliary valve controlled self-cleaning main valve with mechanical operating means according to any of claims 1-3 characterized in that said control valve stem (7) of said auxiliary valve (4) is pressed to the closing surface of said auxiliary valve (4)-by means of threads (18) rotated with arm (15).
